(19) United States
(12) Patent Application Publication
(10) Pub. No.: US 2021/0097501 A1
(43) Pub. Date: Apr. 1, 2021

(54) ONLINE MARKETPLACE FOR ORGANIZING FUNERALS

(71) Applicant: BLUEBIRD VENTURES PTY LTD, FOOTSCRAY (AU)

(72) Inventor: ASHA LEENA ROSEMARY MARTIN, MAIDSTONE (AU)

(21) Appl. No.: 16/597,768

(22) Filed: Oct. 9, 2019

(30) Foreign Application Priority Data
Sep. 29, 2019 (AU) 2019903655

(51) Int. Cl. G06Q 10/10; G06Q 20/22

(52) U.S. Cl. CPC G06Q 10/1095; G06Q 20/223

(57) ABSTRACT

An online marketplace for organizing funerals, the online marketplace includes: a software application for funeral service providers and customers; a server connected to the software application; and a way of communicating between the software application and the server; the software application is adapted to allow customers to send invitations which allow the invitee to make a financial contribution to the cost of the funeral.

### TECHNICAL FIELD

The present invention relates to the funeral industry and, more particularly to an online marketplace for organising and purchasing funerals.

### BACKGROUND

There are numerous problems in the funeral industry. For example, a large proportion of families arranging funerals are faced with unplanned funeral costs, such as the costs of caskets, flowers, cemetery and crematorium fees. The person who organises a funeral typically incurs an average debt of $8,000. This expense often arises at an unexpected time and is not within the budget of the organisers.

Another problem is that people cannot easily book funerals for the death of their loved ones. Funeral home directors also lack tools to easily communicate with clients. Funeral home directors often struggle to collect payments from their clients after the service. Many funeral service providers are so concerned with retaining the client (because of fierce competition in the marketplace) that they provide the service before the payment is made. In addition, funeral service providers often spend an excessive and unprofitable amount of time providing quotes for different funeral options and managing customer relations.

The object of the present invention is to overcome or at least substantially ameliorate the aforementioned problems with funerals.

### SUMMARY OF THE INVENTION

According to the present invention, there is provided an online marketplace for organising funerals, the online marketplace comprising:

(a) a software application for funeral service providers and customers;
(b) a server connected to the software application; and
(c) a means of communicating between the software application and the server;
wherein the software application is adapted to allow customers to send invitations which allow the invitee to make a financial contribution to the cost of the funeral.

The software application is preferably adapted to allow the customer to purchase optional goods and services for the funeral. The software application is preferably adapted to allow the customer to apply for finance to pay for the cost of the funeral which is customized within the software application. The software application is preferably adapted to provide a map which shows the location of funeral service providers utilizing the online marketplace and accessible to customers. The software application preferably provides a communications portal between funeral service providers and their customers to organize the funeral.

The software application may be adapted to share a funeral notice planned on the system via social media. The software application may be adapted to issue periodic reminders to invitees about the upcoming funeral. The software application may be adapted to allow the customer to design and publish the funeral notice. The software application preferably provides an RSVP management tool for the funerals. The software application may also be adapted to provide an automated eulogy generator for the customer.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a depiction of funeral home director and a customer interacting on the online funeral marketplace of the present invention.

FIG. 2 is a depiction of the map on a mobile phone running the software application of the present invention and showing search results for funeral homes in a particular geographic area.

FIG. 3 is depiction of a listing for a funeral home on the software application of the present invention.

FIG. 4 is depiction of the configurable options for goods and services in a funeral, displayed on a mobile phone running the software application of the present invention.

FIG. 5 shows an automatic eulogy generator within the software application of the present invention.

FIG. 6 is a depiction of a funeral finance application form which may be submitted within the software application of the present invention.

FIG. 7 is a depiction of communications portal between a funeral service provider and a customer on the software application of the present invention.

FIG. 8 is a funeral advertisement notice generated by the software application of the present invention.

FIG. 9 is an invitation automatically generated by the software application of the present invention for an invitee to financially contribute to the costs of the funeral.

FIG. 10 is a funeral fundraising page within the software application of the present invention.

FIG. 11 is an invitation management tool for a funeral within the software application of the present invention.

### DETAILED DESCRIPTION

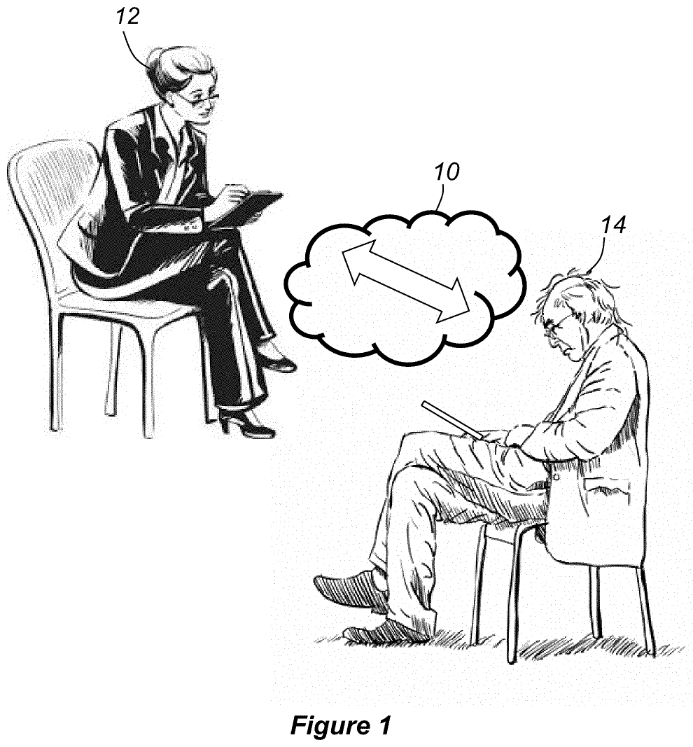

FIG. 1 shows a conceptual depiction of the online marketplace 10 software application of the present invention being used by a funeral service provider 12 and a funeral customer 14.

The customer 14 can select a funeral home by searching based on geographic location, proximity to the customer, service offerings, feedback (i.e. ratings for funeral homes by other customers), and/or price.

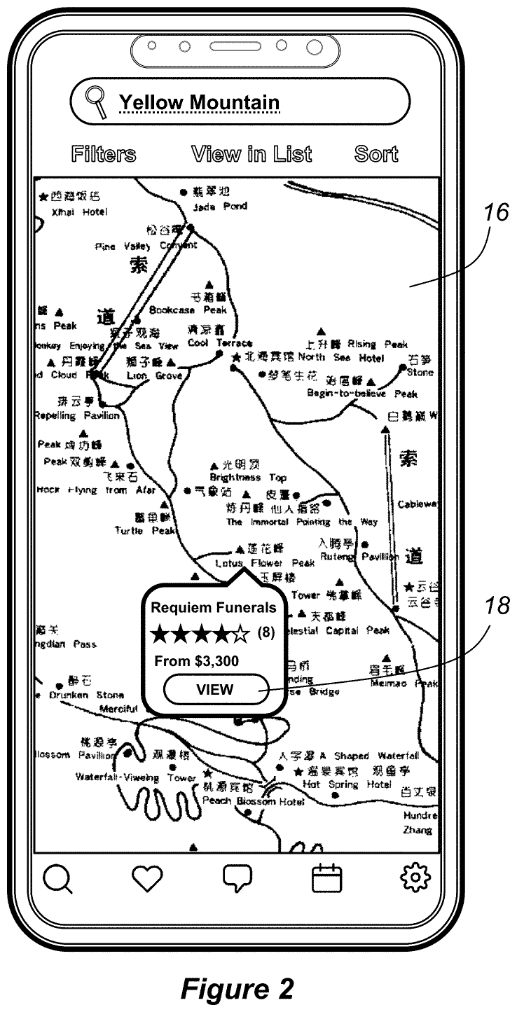

FIG. 2 shows a depiction of map page 16 of the software application with a search result for a particular funeral home, namely, Requiem Funerals. The software application displays the rating of the funeral home compiled from the reviews of multiple other customers. The software application enables the user to view the offerings of the service provider (Requiem Funerals) by clicking the “view” button 18.

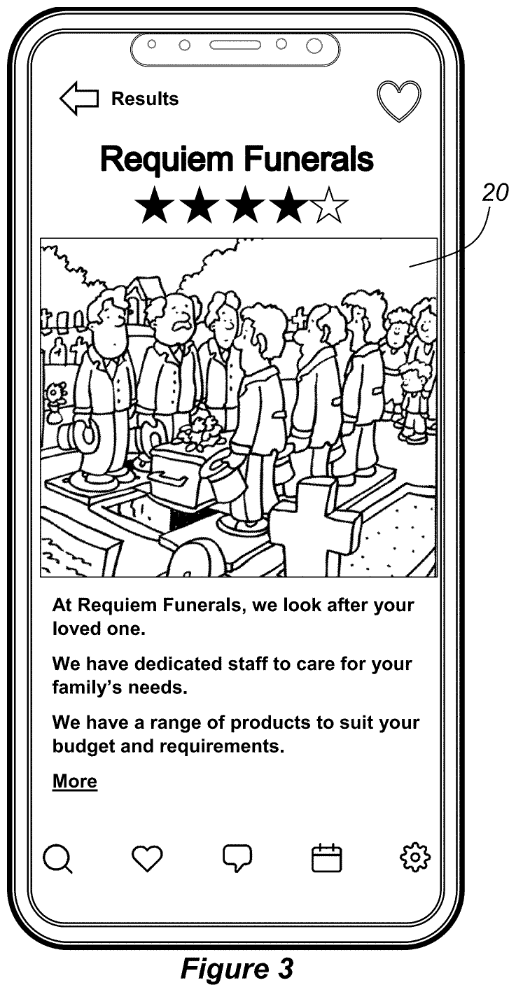

FIG. 3 shows the listing page 20 for Requiem Funerals, which includes photographs of its funeral service venue. This helps the customer decide whether they want their loved one's funeral to take place at that particular funeral home. The listing enables the customer to access information such as customer reviews.

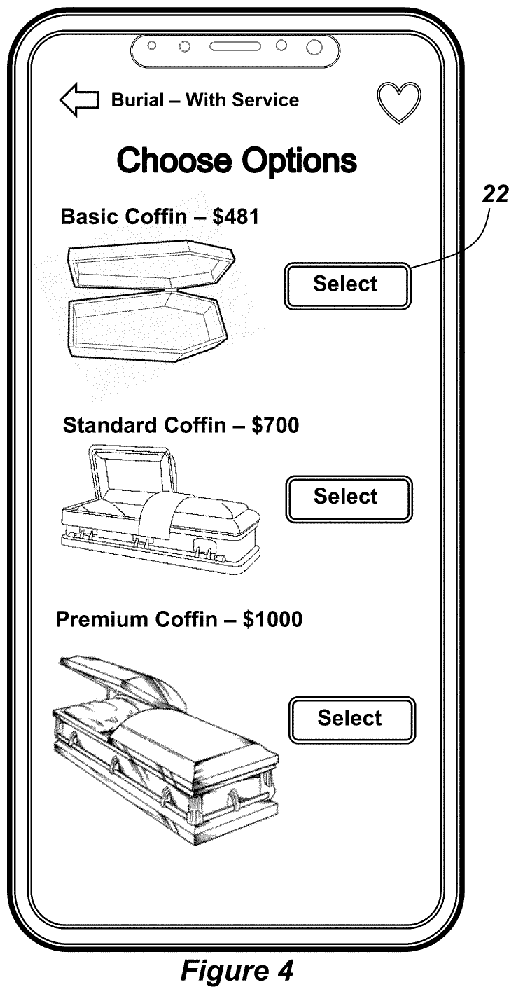

The view button 18 (see FIG. 2) takes the customer 14 to options page 22 shown in FIG. 4. The option page 22 enables the customer to select goods and services for the funeral, such as the casket, food catering, flower arrangements, decorations, memorial books, funeral attendee books, service program bulletins, cemetery plaques, monuments, headstones and graves.

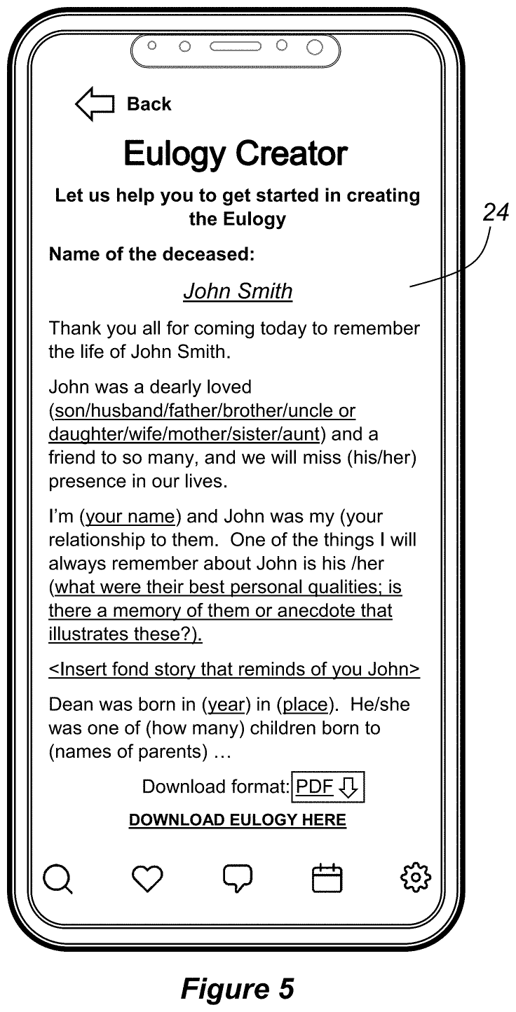

FIG. 5 shows a eulogy generator 24 within the software application of the present invention. The eulogy generator can assist customers to populate the content of a standard format eulogy. This is advantageous because it reduces the workload on grieving customers.

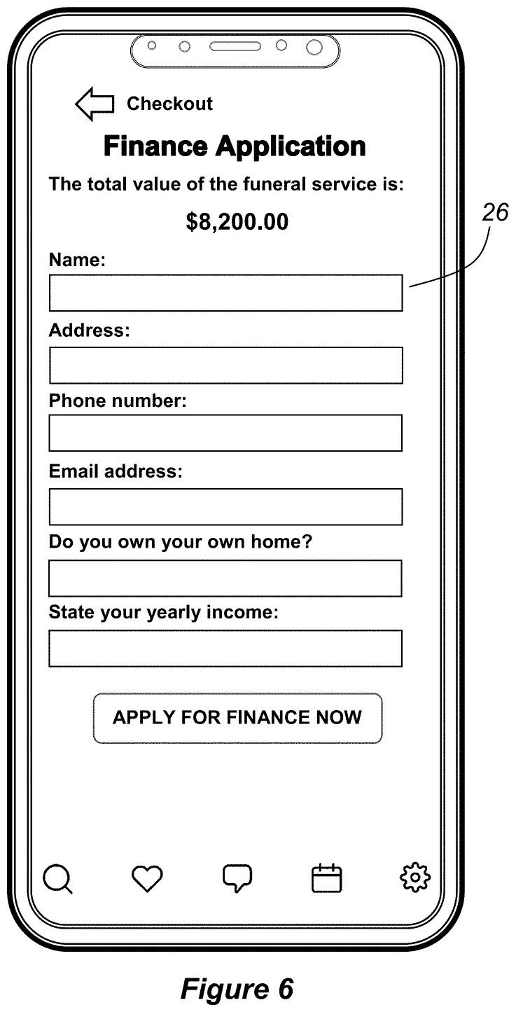

FIG. 6 shows a finance application form 26 which is integrated into the software application of the present invention and enables the costs of the funeral to be paid off by the customer over time. The finance application form 26 requires the input of some basic financial information which is then considered by a finance company. This eases the otherwise sudden financial burden of the costs of the funeral on the loved ones of the deceased.

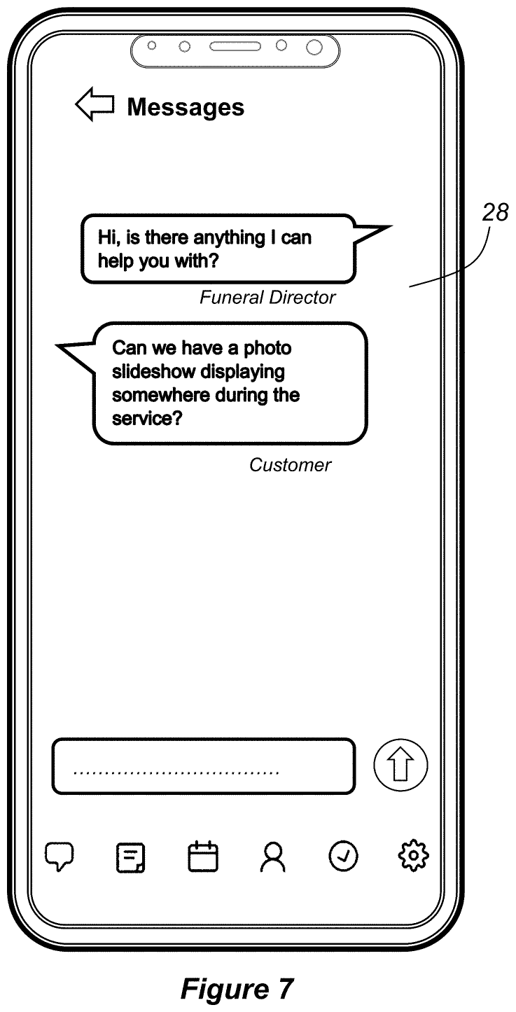

FIG. 7 shows the communications portal page 28 which enables the customer to keep a record of correspondence with the funeral service providers utilising the software application of the present invention.

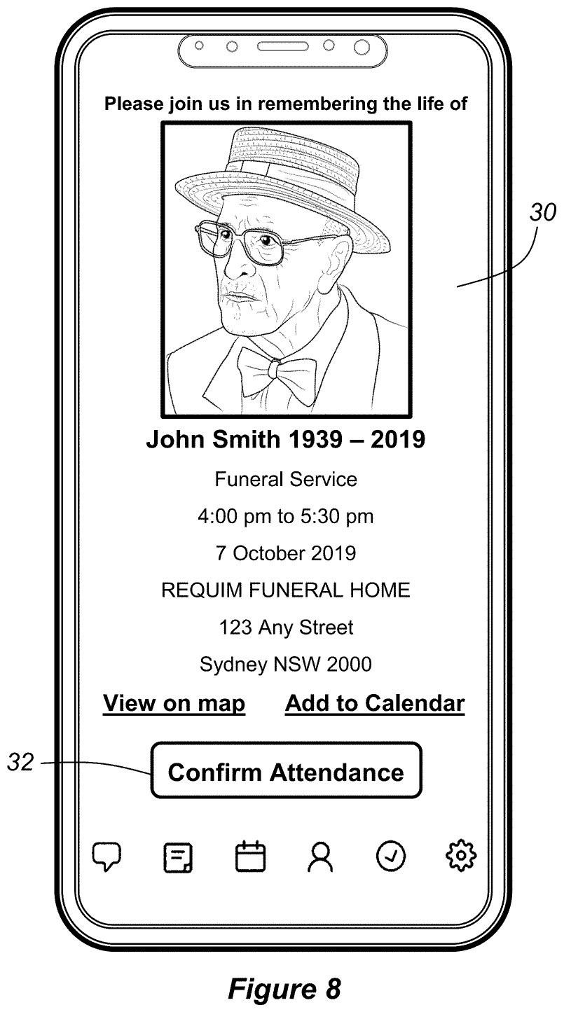

FIG. 8 shows a funeral notice 30 which was automatically generated by the software application of the present invention. The content of the notice 30 is compiled from data input by the customer but presented in a standardized and readable format. The funeral notice 30 includes a “confirm attendance” button 32, which enables a recipient to easily rsvp for the funeral. The software application is adapted to automatically issue reminders regarding an upcoming funeral to attendees.

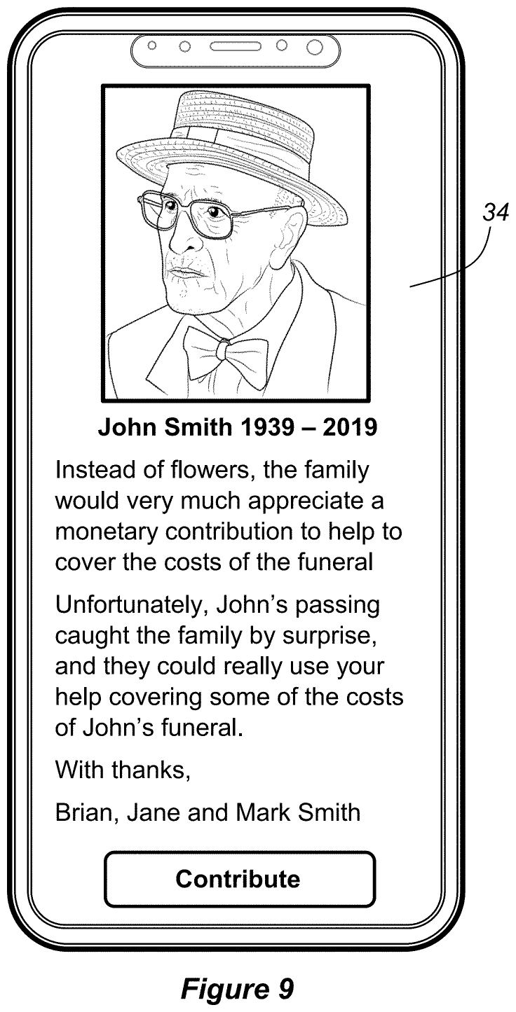

FIG. 9 shows a message 34 automatically dispatched by the software application at the option of the customer 14. The message 34 invites attendees to contribute to the cost of the funeral. This message can greatly alleviate the financial burden on the organisers of the funeral.

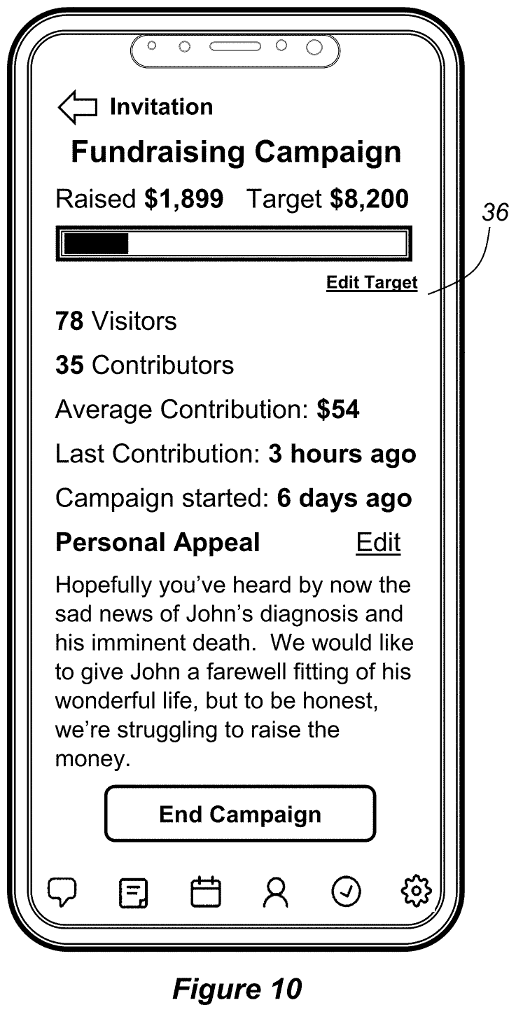

FIG. 10 is fundraising campaign page 36 which shows the current level of financial contributions made by third parties in response to the message 34 dispatched by the online marketplace software application 10 of the present invention. This enables the customer to see (in real time) their level of remaining debt from the funeral.

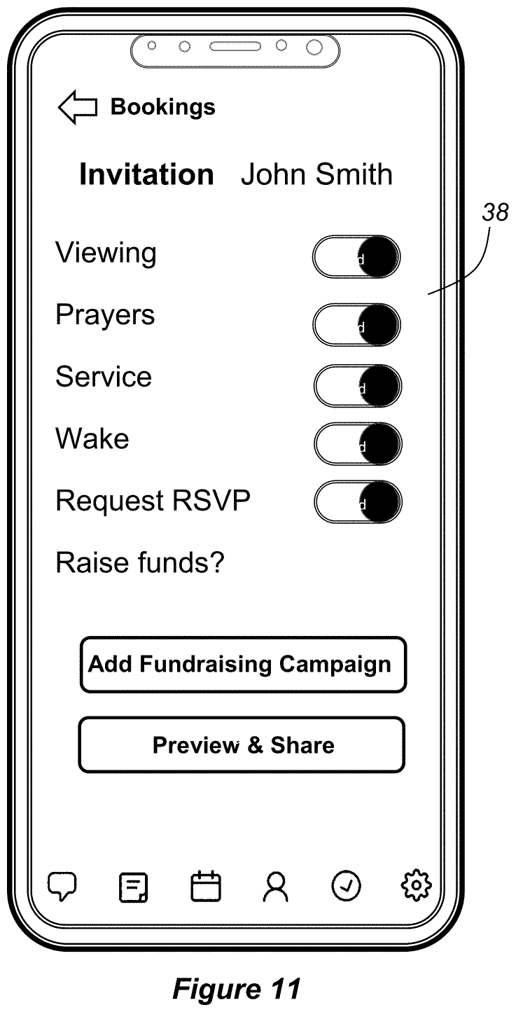

FIG. 11 is invitation customisation page 38, which enables the customer 14 to select the options for the invitation message 34. These options include whether the customer 14 wants to invite attendees to a viewing, prayer service, funeral service and wake; whether to request a rsvp from the invitee and whether to request financial contributions to the cost of the funeral.

### CONCLUDING REMARKS

In the present specification and claims (if any), the word ‘comprising’ and its derivatives including ‘comprises’ and ‘comprise’ include each of the stated integers but does not exclude the inclusion of one or more further integers. The use of ‘a’ or ‘an’ in patent claims or the specification means ‘one or more.’

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An online marketplace for organizing a funeral, the online marketplace comprising:
(a) a software application for a funeral service provider and a customer;
(b) a server connected to the software application; and
(c) a means of communicating between the software application and the server;
wherein the software application is adapted to allow a customer to send an invitation which allows an invitee to make a financial contribution to the cost of the funeral.

2. The online marketplace of claim 1, wherein the software application is adapted to allow the customer to customize and purchase optional goods and services for the funeral.

3. The online marketplace of claim 1, wherein the software application is adapted to allow the customer to apply for finance to pay for the cost of the funeral which is customized within the software application.

4. The online marketplace of claim 1, wherein the software application is adapted to provide a map which shows the location of the funeral service provider utilizing the online marketplace and accessible to the customer.

5. The online marketplace of claim 1, wherein the software application provides a communications portal between the funeral service provider and the customer to organize the funeral.

6. The online marketplace of claim 1, wherein the software application is adapted to share a funeral notice planned via social media.

7. The online marketplace of claim 1, wherein the software application is adapted to issue a periodic reminder to the invitee about the upcoming funeral.

8. The online marketplace of claim 6, wherein the software application is adapted to allow the customer to design and publish the funeral notice.

9. The online marketplace of claim 1, wherein the software application provides an RSVP management tool for the funeral.

10. The online marketplace of claim 1, wherein the software application provides an automated eulogy generator.
